(19) United States
(12) Patent Application Publication
(10) Pub. No.: US 2009/0199468 A1
(43) Pub. Date: Aug. 13, 2009

(54) Floral display unit and system

(75) Inventor: Gino Emmanuel Gioia, Ryde (AU)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Lynch Group Australia Pty Limited, Moorebank (AU)

(21) Appl. No.: 12/069,204

(22) Filed: Feb. 8, 2008

(51) Int. Cl. A01G 5/04; A47G 7/02; B32B 1/08

(52) U.S. Cl. 47/41.01; 428/34.1

(57) ABSTRACT

A floral display unit and system is disclosed. The unit comprises a tubular body having an imaginary central axis. In use the imaginary central axis is orientated vertically. Opposite first and second ends are spaced apart along the axis. The first end forms an upper end of the body arranged to receive a floral display and the second end forms a lower end. There are one or more side walls extending between the ends.

### FIELD OF THE INVENTION

The present invention generally relates to a floral display unit aid a floral display system.

### BACKGROUND OF THE INVENTION

Floral display units are typically found in florists, petrol stations, supermarkets, outside local shops, etc. and are used to display floral material such as flowers, attractive foliage, buds, plants and bonsai. Floral material may be arranged, potted or bunched in a decorative fashion and the resulting arrangement; pot or bunch is typically ready for purchase by a customer. Floral display units allow floral material to be displayed in a favourable fashion. It will be appreciated that the better the display the more likely it is that the customer will purchase a floral arrangement. Floral display units also meet practical requirements that depend on the environment and circumstances in which they are used.

### SUMMARY OF THE INVENTION

According to one aspect of the invention there is provided a floral display unit comprising:

a tubular body having an imaginary central axis orientated vertically in use;
opposite first and second ends spaced apart along the axis, the first end forming an upper end of the body arranged to receive a floral display and the second end forming a lower end; and
one or more side walls extending between the ends.

According to another aspect of the invention there is provided a blank of sheet material for a floral display unit, the floral display unit comprising:

a tubular body having an imaginary central axis orientated vertically in use;

opposite first and second ends spaced apart along the axis, the first end forming an upper end of the body arranged to receive a floral display and the second end forming a lower end; and

one or more side walls extending between the ends.

In some embodiments the floral display is a container holding floral material and the upper end is open to receive the container. The upper end may include a rim around the open end arranged to support the container. The rim around the open and may be arranged to engage a flange attached adjacent a rim of the container. The rim may include an extension portion of the one or more side walls folded over. The extension portion may have a trapezoidal like shape.

In some embodiments the body has a profile in axial cross-section that allows a plurality of display units to be tessellated. That is, a plurality of display units may tile or cover a surface onto which they are placed. A tesselation may be either complete or incomplete by, for example, the absence of one unit from its expected position. The cross-sectional profile of the tubular body may be polygonal. The tubular body may have a hexagonal cross-sectional profile. The hexagonal cross-sectional profile allows a plurality of display units to be adjacently located to each other in a honeycomb arrangement. The hexagonal cross section may provide improved stability of the display unit compared with, for example, a circular cross section. In some embodiments adjacent display units may support each other for even greater stability. The display units may be adjacently located to each other in a creative or artistic arrangement. The cross sectional profile of the body may be constant along its length.

In some embodiments the unit is arranged to be supported in use on the second end of the body. The second end of the body may sit on a surface, for example a floor surface, a table top surface, a ground surface, or any other suitable surface. In alternative embodiments, the unit is arranged to be supported in use by a stand engaging the unit.

In some embodiments the tubular body is arranged in use to adopt an expanded condition and is able to also adopt a collapsed condition where the tubular body is closed upon itself.

In some embodiments the side walls are rectangular. The rectangular side walls may be attached to each other by a hinge. The rectangular side walls may be formed of a bendable material and the hinge may be continuous with the rectangular side walls. The hinge may be a fold line. The display unit may be moved between the expanded and collapsed conditions by opening one or more of the hinges and closing one or more of the remaining hinges.

The blank of sheet material may include a tear line arranged to provide two new blanks of sheet material from the blank of sheet material on tearing along the tear line.

According to yet another aspect of the invention there is provided a floral display unit comprising:

a tubular body having an imaginary central axis orientated vertically in use;

opposite first and second ends spaced apart along the axis, the first end forming an upper end of the body arranged to receive a floral display and the second end forms a lower end; and

one or more side walls extending between the ends;

wherein the tubular body is arranged in use to adopt an expanded condition and is able to also adopt a collapsed condition where the body is closed upon itself.

The tubular body may include fold lines or hinges that facilitate movement between the collapsed and expanded conditions. The fold lines or hinges may extend in the direction of the axis. The body may include a plurality of side walls and the fold lines or hinges maybe disposed at the join between respective ones of the side walls.

According to still another aspect of the invention there is provided a floral display system comprising a plurality of connected floral display units to form a tessellation.

According to still yet another aspect of the invention there is provided a floral display system comprising a plurality of floral display units, the display units being interconnected by hinges that allows the system to adopt a collapsed condition where the respective units are in their collapsed condition and an expanded condition where an upper ends of the respective units are arranged to receive a floral display.

The respective units may have a profile in axial cross-section that allows tessellation of one of the units with the other units, and the display units are tessellated.

In some embodiments the lengths of respective unit are identical. In alternative embodiments at least two of the plurality of floral display units may have different lengths.

According to even another aspect of the present invention, there is provided a blank of sheet material for a floral display unit, the blank comprising a rectangular sheet section having a plurality of fold lines parallel to a side of the rectangular sheet section, the fold lines dividing the rectangular sheet section into rectangular side wall proportions.

In some embodiments, the edge of at least one of the rectangular side wall proportion includes a respective extension proportion arranged to fold onto the side wall portion. The blank may include a tear line running across the foldlines. The blank may include tab portion located adjacent one side of the rectangular sheet section and the tab portion being arranged to be fastened adjacent an opposite side of the rectangular sheet portion.

### BRIEF DESCRIPTION OF THE DRAWINGS

In order to achieve a better understanding of the nature of the invention an embodiment of a floral display unit and a floral display system will now be described, by way of example only with reference to the accompanying figures in which:

FIG. 1 shows a perspective view of one embodiment of a floral display unit according to one aspect of the invention and a floral display to be received by the floral display unit;

FIG. 2 shows one embodiment of a floral display system according to another aspect of the invention;

FIGS. 3 to 7 each show a plurality of floral display units of FIG. 1 placed adjacent to each other in various advantageous arrangements;

FIG. 8 shows one embodiment of a blank of sheet material for a floral display unit including a tear line according to yet another aspect of the invention;

FIGS. 9 and 10 show the two blanks that result from tearing along the tear line of the blank in FIG. 8;

FIG. 11 shows plan views of tessellated display units in: (a) a complete honeycomb tessellation; (b) an incomplete honeycomb tessellation; (c) an incomplete triangular tessellation; and (d) an irregular tessellation.

### DETAILED DESCRIPTION OF ILLUSTRATIVE EMBODIMENTS

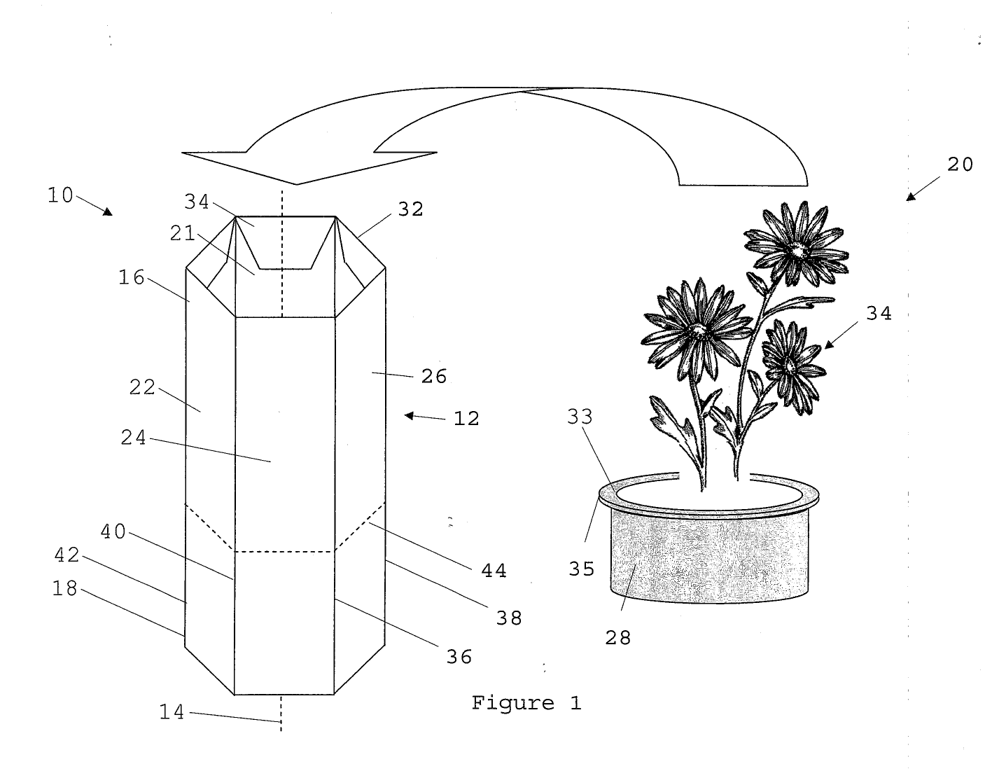

FIG. 1 shows one embodiment of a floral display unit which is generally indicated by the numeral 10. The floral display unit 10 has a tubular body 12 which itself has an imaginary central axis 14. In use, the tubular body is generally upright and thus the imaginary central axis is orientated vertically. The floral display unit 10 has a first end 16 and an opposite second end 18 spaced apart along the imaginary axis 14. The first end 16 forms an upper end of the body 12 which is arranged to receive a floral display such as 20. The upper end 16 is open to receive the floral display 20, which in this embodiment is a container or bucket 28 holding floral material 34. The second end 18 forms a lower end. There are one or more side walls such as 22, 24 and 26 which extend between the ends 16 and 18.

The upper end 16 of the unit 10 includes a rim 32 which is arranged to engage a flange 35 attached adjacent a rim 33 of the bucket 28. In this embodiment, the rim 32 of the upper end 16 includes an extension portion 34 having a trapezoidal like shape which is folded onto the inside of side wall 21. This acts to reinforce the rim 32 in preparation to engage the flange 35 of the container 28.

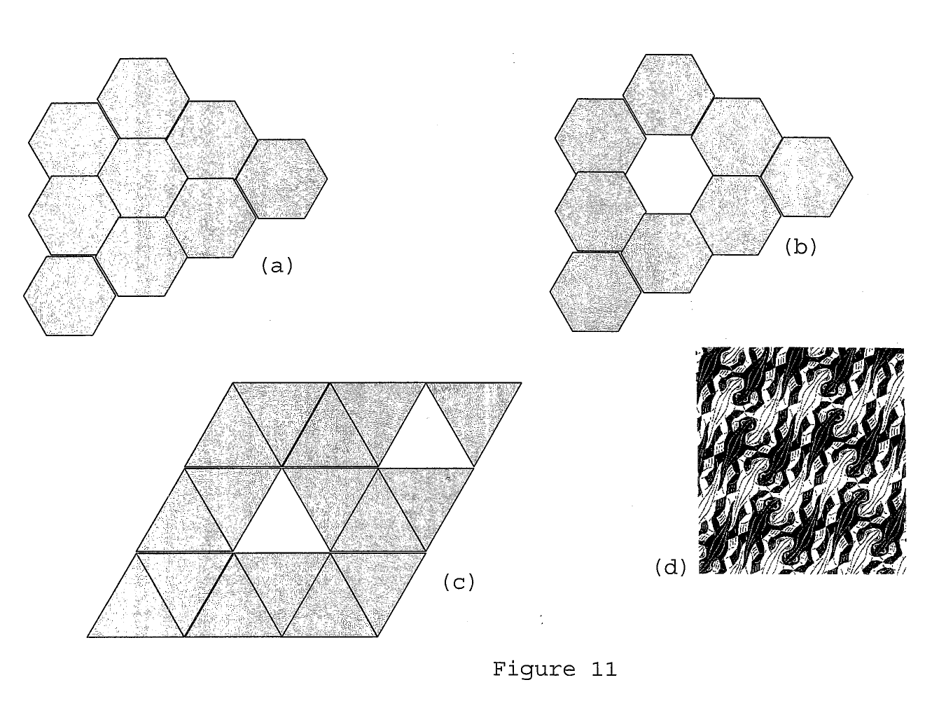

The axial cross section of this embodiment describes a polygon, and in particular is hexagonal. This is one example cross section that allows the floral display unit to be tessellated with others. Example tessellations are shown in FIG. 11. A plurality of floral display units can be close packed together to completely cover any portion of a surface adjacent the lower end 18 of the floral display units 10. In particular, the hexagonal cross-sectional profile allows a plurality of display units to be adjacently located to each other in a honeycomb arrangement. However, it will be understood that the honeycomb or any such tessellated arrangement may have defects, for example some of the units may be missing from their nominal or expected position.

The display units, such as 10, are thus adjacently located to each other in a condition where upper ends of the respective units are arranged to receive each respective floral display such as 20. The hexagonal cross section is a profile that provides improved stability of the display unit compared with, for example a circular cross section while being more space efficient than a square cross-section. A hexagon better fits the circular cross section of the bucket than a square does which wastes substantial space in each corner. It is not necessary for each of the display units to have a constant cross sectional profile along its length.

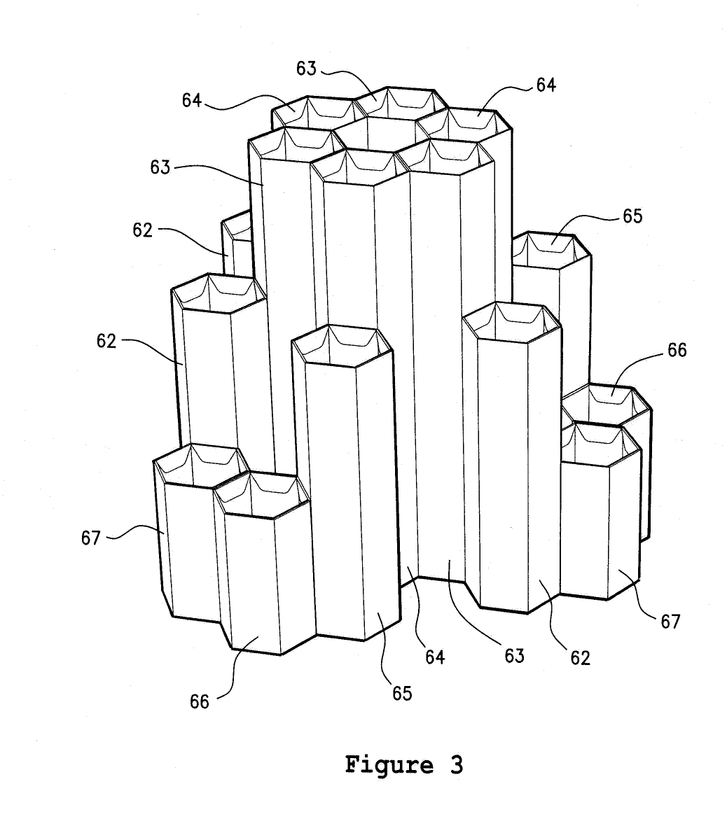

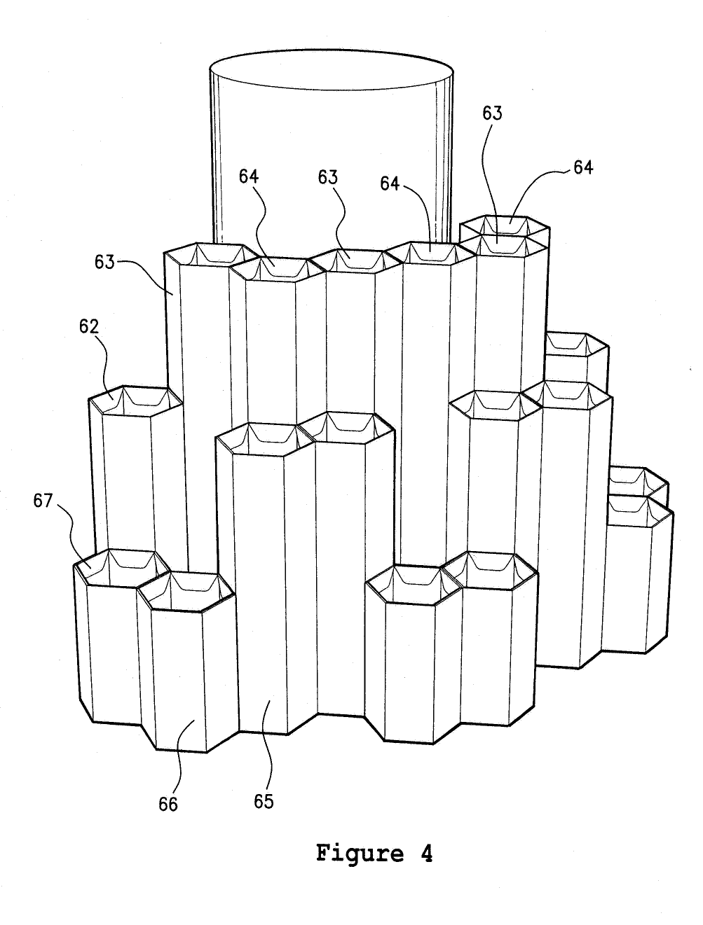

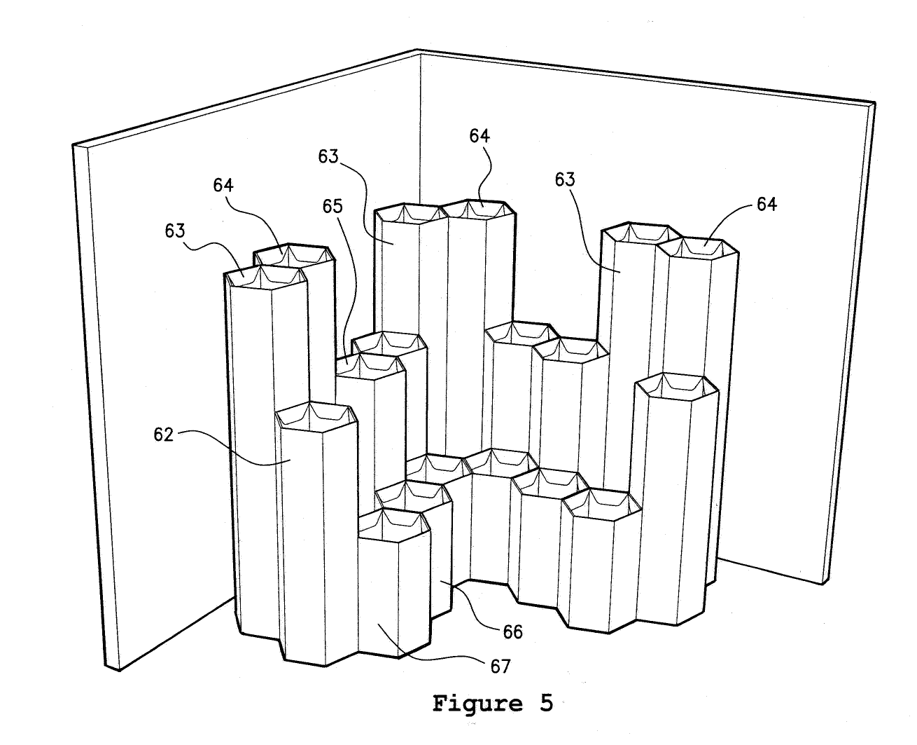

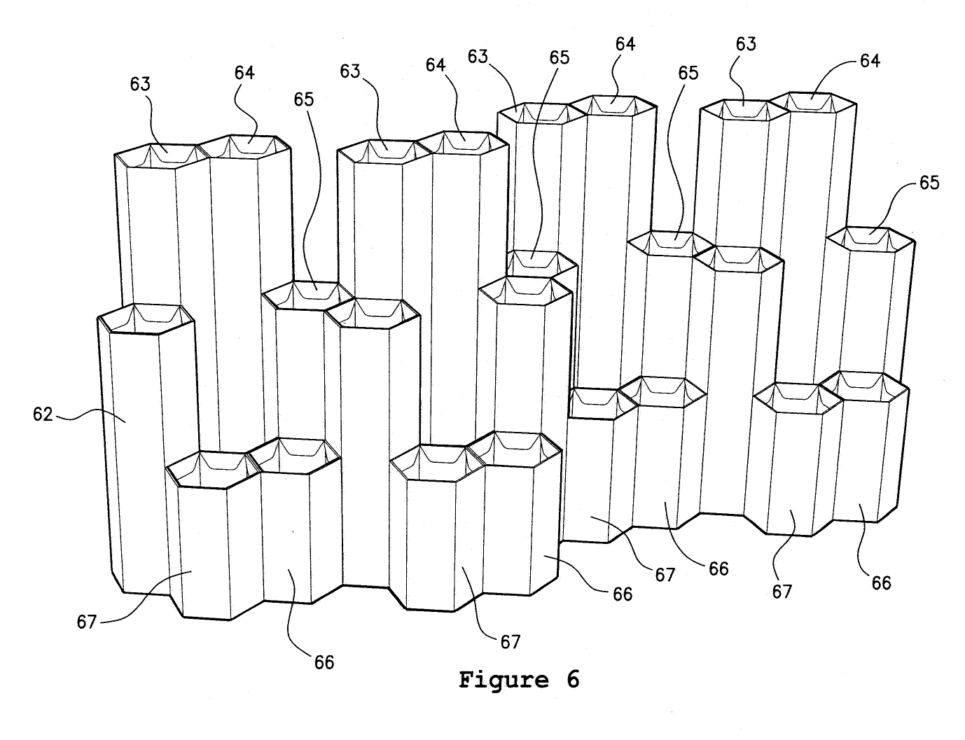

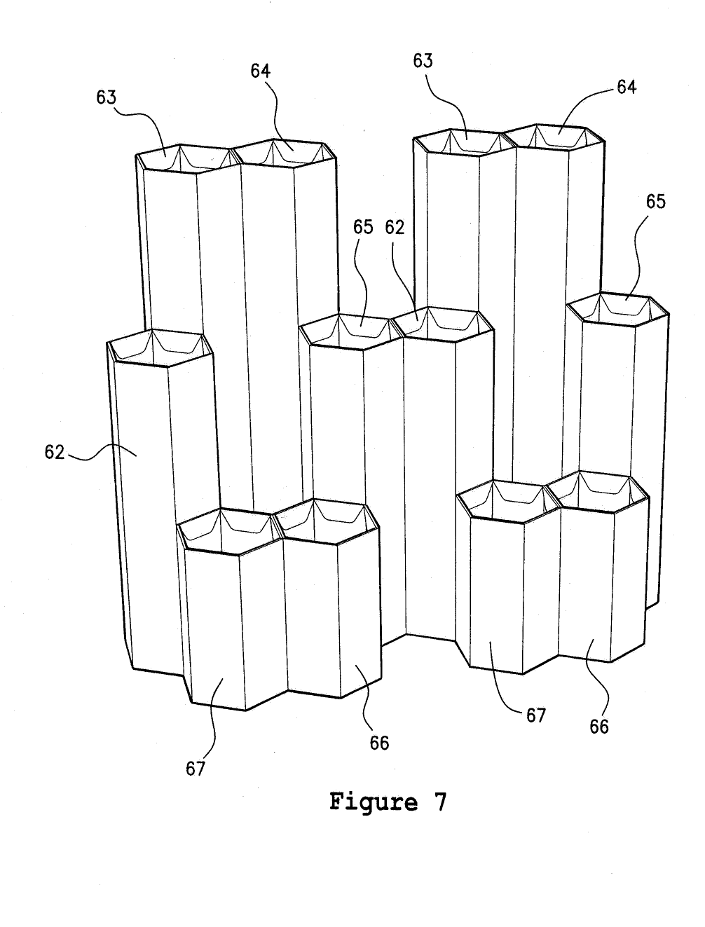

The display units such as 10 can be adjacently located to each other in a creative or artistic arrangement. For example, FIG. 3 shows the display units 63-67 arranged as a central pillar, FIG. 4 shows the display units 63-67 arranged in part around a pillar, FIG. 5 show the display units 63-67 arranged in a corner, FIG. 6 shows display units 63-67 arranged along a wall 101, and FIG. 7 shows further display units 63-67 arranged along a wall 101. Not only are these displays attractive but they can be tailored to the floor plan of a shop in which they are contained. In these examples, the lengths of the display units such as 62 and 64 are of different length. This allows a plurality of floral displays to be terraced or displayed at different heights.

In the embodiment of FIG. 1 the lower end 18 is arranged to sit on a surface (not shown), for example a floor, a table top, a ground surface, or any other suitable surface. However it would be understood that the unit may be arranged to be supported by a stand which engages the unit, for example, at the lower end 18. A tripod stand may be used on uneven ground, for example. Stands of different height could be used to achieve a tiered effect.

In the embodiment of FIG. 1, the side walls such as 22, 24 and 26 are rectangular. The side walls may include fold lines such as 36, 38, 40 and 42. The fold lines such as 36 are disposed at the join between respective side walls such as 24 and 26. The fold line or hinge 36, for example, may be continuous with the rectangular side walls 24 and 26. The side walls such as 26 may be formed of a bendable material to facilitate the hinge action.

The foldlines or hinges such as 36 allow the tubular body to adopt an expanded condition, such as shown in FIG. 1, and also to be able to adapt collapsed condition where the tube 10 is closed upon itself and essentially flat. The fold lines or hinges such as 36 facilitate movement of the tubular body 16 between the collapsed and the expanded position. The display unit 10 may be moved between the expanded and collapsed conditions by opening one or more of the hinges or fold lines such as 36 and closing one or more of the remaining hinges such as 38. Placing a container or bucket 28 in the open end 16 prevents the unit 10 from collapsing.

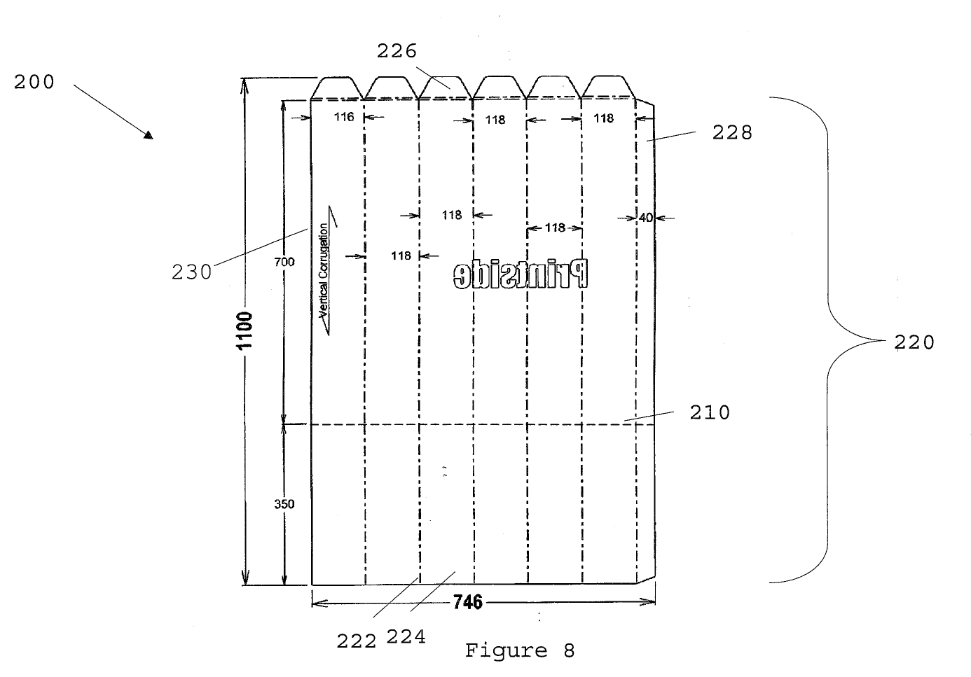

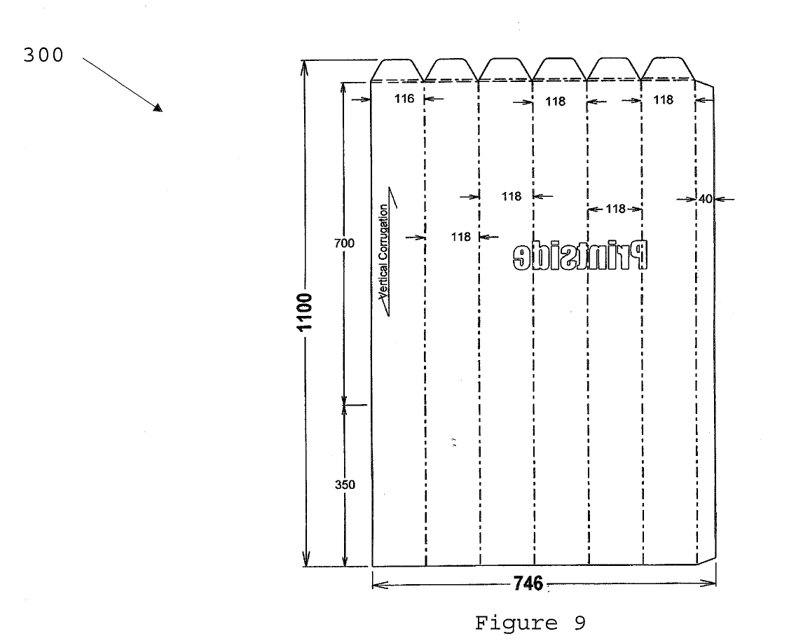

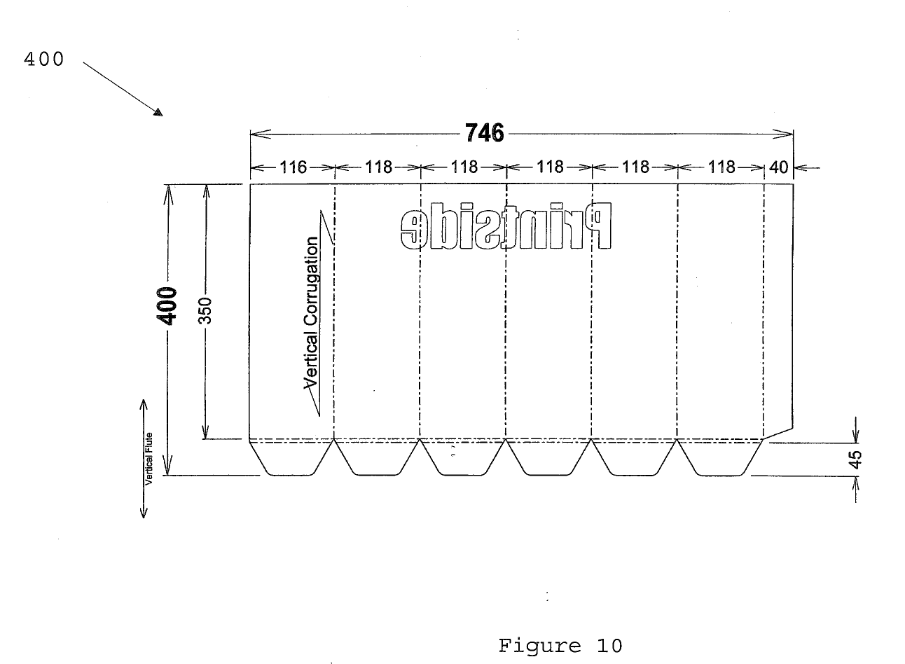

The display unit may be manufactured from a blank of sheet material 200 such as that shown in FIG. 8. The sheet material 200 may comprise any one or more of fibreboard, corrugated cardboard, paper board, reinforced cardboard, polymer sheet, CORFLUTE™ or any other suitable and/or similar material. CORFLUTE™ is manufactured by Corex Plastics Australia Pty Ltd. CORFLUTE™ is not adversely affected by water, oil or many solvents, and therefore suitable for use in floral display units. The blank of sheet material 200 includes a rectangular sheet section 220. This rectangular sheet section 220 has a plurality of fold lines such as 222 which divide the rectangular sheet section 220 into rectangular side wall portions such as 224. In this embodiment each of the rectangular side wall portions such as 224 include a respective section portion such as 226 arranged to fold onto each side wall portion. The blank 200 include a tab portion 228 located adjacent one side of the rectangular sheet section 220 and arranged to be fastened adjacent an opposite side 230 of the rectangular sheet section 200. The blank of sheet material 200 include a tear line 210 running across the fold lines 222 arranged to provide the two new blanks 300 and 400 shown in FIGS. 9 and 10. The tear line 210 shown in FIG. 8 is, in this embodiment, located away from the centre to offer three display units of different height, such as shown in FIG. 3. In this embodiment, the tear line is located approximately one third of the distance along the tube. Thus one of the resulting tubes will be twice the length of the other. The tear along the tear line may be performed before or after the display units are assembled from the sheet material. A tear line is also shown in the assembled floral display unit 10 of FIG. 1 and indicated by the numeral 44. It will be understood that the display unit can be torn along the tear line 44 and that two display units will result.

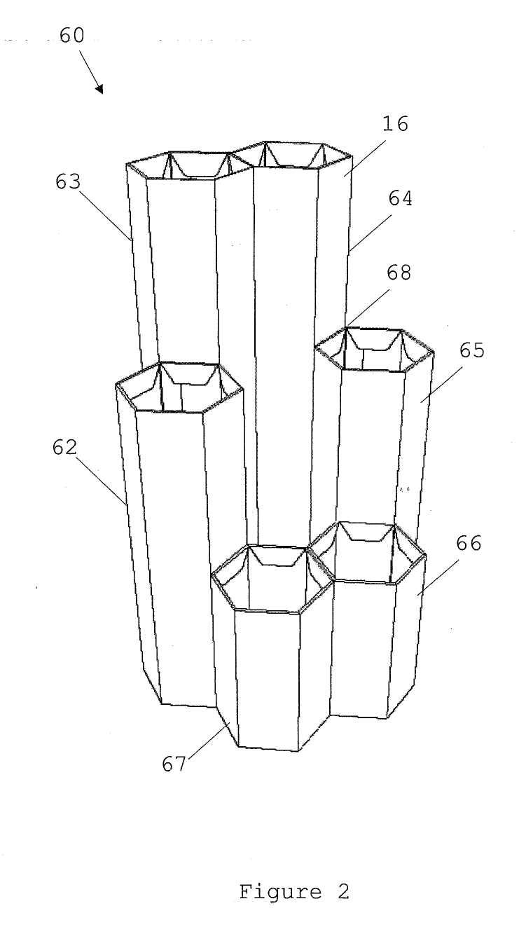

FIG. 2 shows one embodiment of a floral display system 60 comprising a plurality of tessellated and connected floral display units 62-67. The system 60 comprises the six units 62-67 in a ring arrangement. The ring arrangement affords a high level of stability for the system. In the embodiment of FIG. 2, each of the display units 62-67 have a hexagonal cross section and thus can be tessellated to cover a portion of a surface (now shown). In this embodiment, however, a central or middle display unit has been removed. It will be appreciated that the embodiment of a floral display system 60 shown in FIG. 2 provides a modular and flexible solution while being easier to handle and quicker to arrange than a collection of 6 similar but disconnected floral display units. All of the various arrangements shown in FIGS. 3-7 can be achieved with 3, 3, 3, 4 and 2 floral display systems such as 60 respectively, instead of 18, 18, 18, 24 and 12 display units. In this embodiment, the display units are connected by adhesive placed on opposing adjacent faces of the respective units. The display units of system 60 support each other for even greater stability than for a single display unit 10. In some embodiments the display units such as 64 and 65 are interconnected by common hinges such as 68 that allows the system 60 to adopt a collapsed condition to an essentially flat state.

Now that embodiments of a floral display unit and a floral display system have been described, it would be appreciated that some embodiments have some of the following advantages:

display units can be arranged in a close packed fashion or tessellated in an infinite number of ways which allows for the creation of attractive displays;

display units can be adjacently located, each of the display units having a different height to allow a tiered display, stepped, tiered or terraced displays rhaximise the visual area available to the eye showing a fuller display with less stock;

the display unit and the display system can be collapsed to an essentially flat state for easy transport and storage,with the pressure to optimise display space, retail outlets are loath to have large or cumbersome storage units which take up value retail floor or storage space;

the display unit is not affected by water, oil or solvents and therefore suitable for a floral display unit;

the units and systems provide a modular solution for the presentation of grouped floral displays, numerous arrangements of a collection of units are possible by adding and/or rearranging units and/or systems;

a small and/or variable display footprint can be achieved, this can optimise retail floor space usage;

accessibility of the flowers to customers can be optimised, for example, arranging the display around awkward objects such as pillars, corners, etc., the effective use of floor space and accessibility to customers increases the likelihood of a sale and the profitability of a retail outlet;

the most appealing display can be rapidly arranged for a particular shop floor configuration, which increases the likelihood of an impulse buy, which accounts for most sales in some floral retail sites;

the modularity allows for the display to be expanded and contracted for the daily trend in floral sales. For example, Fridays and weekends are the bigger selling floral days, so the display can be expanded for these days and made smaller for lower volume days;

connected or attached floral display units can be rapidly constructed to provide an immediate display solution, for example, a 6 unit display comprising 2 tall units, 2 medium units, and 2 short units all connected together as one unit;

by using the honey comb shape, the units fit together and facilitate direct placement of flowers which are already transported in containers such as round flower buckets, the round buckets fit into the hexagonal shape with the lip of the bucket being support by the straight edges of the hexagon, by utilising the buckets for the display there is no need for alternate transport vessels, nor need to handle the product by moving it from a transport vessel to a display unit, it is simply a matter of taking the bucket out of the transport carton and fitting it into a display unit. Floral products benefit greatly from reduction in handling, therefore by enabling one less handling process, the product is displayed unblemished which enhances its appeal to consumers and hence maximizes sales;

the units may be supplied ready for use, they may be delivered flat packed, but as soon as a bucket is placed into the hexagonal hole, they are ready to use, there is no need for assembly, nor special technical abilities;

the unit, once a bucket is put in place, is very stable, despite a small footprint, which is important for a product which is relatively heavy and further needs to be kept in water;

a total display solution is provided, the solution accommodates entire businesses, floral, potted and other arrangements can be displayed equally well. The solution is flexible in the stock it can display;

apart from floral displays, however, the units have limited alternate application, which is useful for a floral supplier who wants the display to be used for their product type, that is, only floral displays;

the units can be sold to stores or outlets with no existing display units as a total retail solution without the need to invest in heavy and expensive metal or wooden shelving units, the flat packed display can be delivered with a stock of flowers for an instant floral display package, so opening up many floral retail opportunities, for example at milk bars, school fetes, liquor outlets, workplaces, charity functions, pubs, etc.;

the units are produced and can be supplied at a relatively low cost, a large display can be cost effectively;

the display is durable, it can be made out of durable plastic CORFLUTE™ material which is reusable and waterproof, which is advantageous when dealing with a ‘wet’ product like floral arrangements;

the display is light weight and easy to assemble;

different material can be printed in any colour on the display units that can be customised to each customer;

the materials used are cost efficient on large production runs, and the units are reusable and thus returnable reducing costs further.

It will be appreciated by persons skilled in the art that numerous variations and/or modifications may be made to the invention as shown in the specific embodiments without departing from the spirit or scope of the invention as broadly described. For example, the cross section of the display units may be any shape that allows the units to be tessellated, such as rectangular, isosceles triangles, trapezoid or any geometrical or amorphous or irregular shape that can be replicated essentially without gaps as exemplified in FIG. 11. The side walls may be metal sheet. The hinges may be piano hinges. The tubes may be capped at an end by a capping member and the floral arrangement placed on it. The side walls may be decorated or emblazoned or printed. The present embodiments are, therefore, to be considered in all respects as illustrative and not restrictive.

What is claimed:

1. A floral display unit comprising:
a tubular body having an imaginary central axis oriented vertically in use;
opposite first and second ends spaced apart along the axis, the first end forming an upper end of the body arranged to receive a floral display and the second end forming a lower end; and
one or more side walls extending between the ends.

2. A floral display according to claim 1 wherein the body has a profile in axial cross-section that allows a plurality of display units to be tessellated.

3. A floral display unit according to claim 1, wherein the unit is arranged to be supported in use on the second end of the body.

4. A floral display unit according to claim 1, wherein the upper end is open to receive a container holding floral material.

5. A floral display unit according to claim 1, wherein a cross-sectional profile of the body is constant along its length.

6. A floral display unit according to claim 1, wherein a cross-sectional profile of the body is polygonal.

7. A floral display unit according to claim 1, wherein the tubular body is arranged in use to adopt an expanded condition and is able to also adopt a collapsed condition where the tube is closed upon itself.

8. A floral display unit comprising:
a tubular body having an imaginary central axis oriented vertically in use;
opposite first and second ends spaced apart along the axis, the first end forming an upper end of the body arranged to receive a floral display and the second end forming a lower end; and
one or more side walls extending between the ends;
wherein the tubular body is arranged in use to adopt an expanded condition and is able to also adopt a collapsed condition where the tube is closed upon itself.

9. A floral display unit according to claim 8, wherein the one or more side walls include fold lines or hinges that facilitate movement of the tube between the collapsed and expanded conditions.

10. A floral display unit according to claim 9, wherein the fold lines or hinges extend in the direction of the axis.

11. A floral display unit according to claim 10, wherein the body includes a plurality of side walls and the fold lines or hinges are disposed at the join between respective ones of the side walls.

12. A floral display system comprising a plurality of tessellated and connected floral display units according to any one of claims 1 to 6 and 11.

13. A floral display system comprising a plurality of floral display units according to any one of claims 8, the system being arranged to adopt a collapsed condition where the respective units are in their collapsed condition and an expanded condition where the upper ends of the respective units are arranged to receive a floral display.

14. A floral display system according to claim 13, wherein the respective units have a profile in axial cross-section that allows tessellation of the unit with other units, and the display units are arranged in a partial or complete tessellated pattern.

15. A floral display system according to any one of claims 12, wherein lengths of unit bodies are constant.

16. A blank of sheet material for a floral display unit, the floral display unit comprising:
a tubular body having an imaginary central axis orientated vertically in use;
opposite first and second ends spaced apart along the axis, the first end forming an upper end of the body arranged to receive a floral display and the second end forms a lower end; and
one or more side walls extending between the ends.

17. A blank of sheet material for a floral display unit, the blank comprising a rectangular sheet section having a plurality of fold lines parallel to a side of the rectangular sheet section, the fold lines dividing the rectangular sheet section into rectangular side wall proportions.
